(19) United States
(12) Patent Application Publication
(10) Pub. No.: US 2025/0155591 A1
(43) Pub. Date: May 15, 2025

(54) RADIATION IMAGING APPARATUS, METHOD FOR EVALUATING RADIATION IMAGING APPARATUS, AND STORAGE MEDIUM

(71) Applicant: CANON KABUSHIKI KAISHA, Tokyo (JP)

(72) Inventors: Masao INA, Kanagawa (JP); Masato OFUJI, Gunma (JP); Kazuaki UMEKAWA, Tokyo (JP)

(21) Appl. No.: 18/942,263

(22) Filed: Nov. 8, 2024

(30) Foreign Application Priority Data
Nov. 14, 2023 (JP) 2023-193921

(51) Int. Cl. G01T 7/00

(52) U.S. Cl. CPC G01T 7/00

(57) ABSTRACT

A radiation imaging apparatus includes an acquisition unit configured to acquire an image from an imaging unit having a plurality of pixels for detecting a radiation, an estimation unit configured to estimate a degradation degree of the radiation imaging apparatus based on the image acquired by the acquisition unit, and a prediction unit configured to predict a life of the radiation imaging apparatus based on a prediction of a transition of the degradation degree of the radiation imaging apparatus acquired by the estimation unit.

### BACKGROUND

### Field

The present disclosure relates to a radiation imaging apparatus, a method for evaluating the radiation imaging apparatus, and a storage medium.

### Description of the Related Art

A certain radiation imaging apparatus includes a sensor substrate, and a scintillator, a drive circuit, and a readout circuit arranged on the sensor substrate. The sensor substrate includes pixels arranged in a two-dimensional matrix form, each of which has a photoelectric conversion element such as a p-intrinsic-n (PIN) diode and a switching element such as a thin film transistor (TFT). Such a radiation imaging apparatus is used not only for medical applications but also for industrial applications such as electronic component inspection and plumbing inspection. Using the radiation imaging apparatus for a prolonged period of time degrades switching elements due to radiation irradiation, possibly decreasing the image quality of captured images. This requires the replacement of the radiation imaging apparatus. In industrial applications, to reduce downtime of the entire apparatus, the radiation imaging apparatus needs to be replaced at an appropriate timing before the apparatus reaches the life. Japanese Patent Application Laid-Open No. 2023-95507 discusses a technique for determining the life of a radiation imaging apparatus by measuring a threshold voltage of switching elements in the radiation imaging apparatus.

The technique discussed in Japanese Patent Application Laid-Open No. 2023-95507 can determine whether the timing of measuring the threshold voltage of switching elements is the life of the radiation imaging apparatus, but cannot predict the time when the radiation imaging apparatus reaches the life in the future.

### SUMMARY OF THE INVENTION

The present disclosure is directed to predicting the life of a radiation imaging apparatus based on acquired image information.

According to an aspect of the present disclosure, a radiation imaging apparatus includes an acquisition unit configured to acquire an image from an imaging unit having a plurality of pixels for detecting a radiation, an estimation unit configured to estimate a degradation degree of the radiation imaging apparatus based on the image acquired by the acquisition unit, and a prediction unit configured to predict a life of the radiation imaging apparatus based on a prediction of a transition of the degradation degree of the radiation imaging apparatus acquired by the estimation unit.

Further features of the present disclosure will become apparent from the following description of exemplary embodiments with reference to the attached drawings.

### BRIEF DESCRIPTION OF THE DRAWINGS

FIG. 1 illustrates an example configuration of a radiation imaging system.

FIG. 2 illustrates an example of a hardware configuration of a control unit and a storage unit of a radiation imaging apparatus.

FIG. 3 illustrates an example of a functional configuration of the control unit and the storage unit of the radiation imaging apparatus.

FIG. 4 is a flowchart illustrating an example of life prediction processing according to a first exemplary embodiment.

FIGS. 5A and 5B illustrate an example of a threshold voltage measurement operation.

FIGS. 6A and 6B illustrate life prediction according to the first exemplary embodiment.

FIG. 7 is a flowchart illustrating an example of the life prediction processing according to a second exemplary embodiment.

FIG. 8 illustrates the life prediction according to the second exemplary embodiment.

FIG. 9 is a flowchart illustrating an example of the life prediction processing according to a third exemplary embodiment.

FIG. 10 illustrates the life prediction according to the third exemplary embodiment.

### DESCRIPTION OF THE EMBODIMENTS

Exemplary embodiments of the present disclosure will be described below with reference to the accompanying drawings. The radiation imaging apparatus according to each exemplary embodiment (described below) is applicable, for example, to an X-ray imaging apparatus for capturing X-ray image data of a subject by using X-rays. The radiation imaging apparatus according to each exemplary embodiment is applicable not only to an X-ray imaging apparatus but also to a radiation imaging apparatus for capturing a radiation image of a subject by using radiations such as a rays, β rays, y rays, particle beams, and cosmic rays.

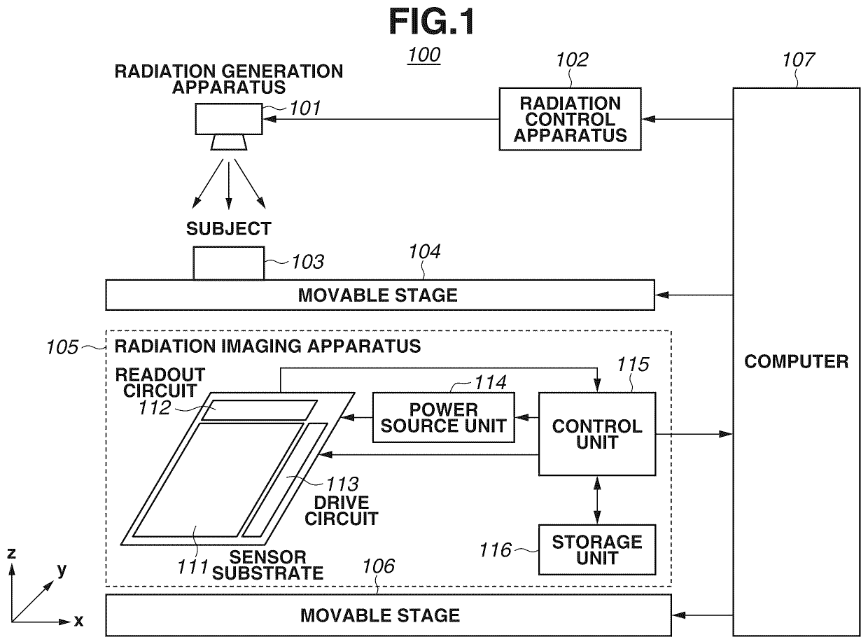

FIG. 1 illustrates an example configuration of a radiation imaging system including the radiation imaging apparatus according to a first exemplary embodiment. FIG. 1 illustrates an inspection system 100 for inspecting electronic components by using radiations, as an example of a radiation imaging system.

A radiation generation apparatus 101 performs radiation irradiation in a conical form in a direction (−z direction) from the radiation generation apparatus 101 to a radiation imaging apparatus 105 in FIG. 1. A radiation control apparatus 102 supplies a high voltage for radiation generation and signals for controlling the start and stop of the radiation generation to the radiation generation apparatus 101.

Movable stages 104 and 106 can move the positions of a subject 103 as an inspection target and the radiation imaging apparatus 105, respectively, with respect to the two axes in the x and y directions. For example, while the movable stage 104 mounting the subject 103 and the movable stage 106 with the radiation imaging apparatus 105 are circularly moving in the x-y plane, the radiation imaging apparatus 105 continuously acquires images to perform oblique computer tomography (CT) imaging. In this example configuration, the subject 103 and the radiation imaging apparatus 105 are moved by the movable stages 104 and 106, respectively. However, the configuration is not limited thereto but other configurations may also be applicable as long as radiation irradiation and image acquisition can be performed while changing relative positions of the radiation generation apparatus 101, the subject 103, and the radiation imaging apparatus 105.

The radiation imaging apparatus 105 includes a sensor substrate 111 for detecting a radiation, a readout circuit 112 for reading information from the sensor substrate 111, a drive circuit 113 for controlling the drive of the sensor substrate 111, and a power source unit 114 for supplying power to these units. The sensor substrate 111 is an example of an imaging unit. The sensor substrate 111 is provided with conversion elements for converting radiation or light into electric charges, and switching elements connected to the conversion elements, and a plurality of pixels for detecting a radiation in a matrix form. Electrical signals according to electric charges accumulated in the conversion elements are output via the switching elements.

The radiation imaging apparatus 105 also includes a control unit 115 for controlling the sensor substrate 111, the readout circuit 112, the drive circuit 113, and the power source unit 114, and a storage unit 116 for storing two-dimensional map (defective pixel map) information for defective pixel (described below). The control unit 115 controls various operations such as imaging operations by the radiation imaging apparatus 105 to enable the radiation imaging apparatus 105 to perform various operations. The control unit 115 can also perform image processing such as forming of image information based on output information from the readout circuit 112.

The inspection system 100 may include a computer 107 for performing control and processing acquired information. The computer 107 controls the radiation control apparatus 102, the movable stages 104 and 106, and the radiation imaging apparatus 105 to enable the radiation imaging apparatus 105 to perform imaging operations and other various operations. The computer 107 can also store images acquired by the radiation imaging apparatus 105 and perform re-configuration of oblique CT images.

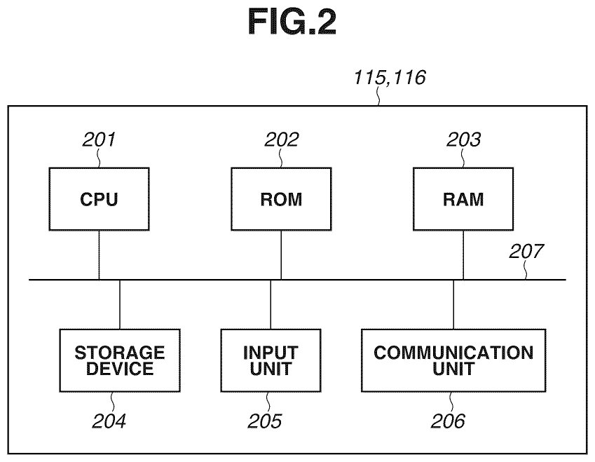

FIG. 2 illustrates an example of a hardware configuration of the control unit 115 and the storage unit 116 of the radiation imaging apparatus 105. The radiation imaging apparatus 105 includes a Central Processing Unit (CPU) 201, a Read Only Memory (ROM) 202, a Random Access Memory (RAM) 203, a storage device 204, an input unit 205, a communication unit 206, and a bus 207. The CPU 201, the ROM 202, the RAM 203, the storage device 204, the input unit 205, and the communication unit 206 are communicably connected via the bus 207.

The CPU 201 reads a control program stored in the ROM 202 and performs various kinds of processing to control various operations by the radiation imaging apparatus 105. The RAM 203 is used as the main memory of the CPU 201 and a temporary storage area such as a work area. The storage device 204 is, for example, a hard disk drive (HDD) or a solid state drive (SDD) for storing various kinds of data and programs. The input unit 205 inputs image data and measurement data such as time and dose. The communication unit 206 performs communication processing with an external apparatus such as the computer 107.

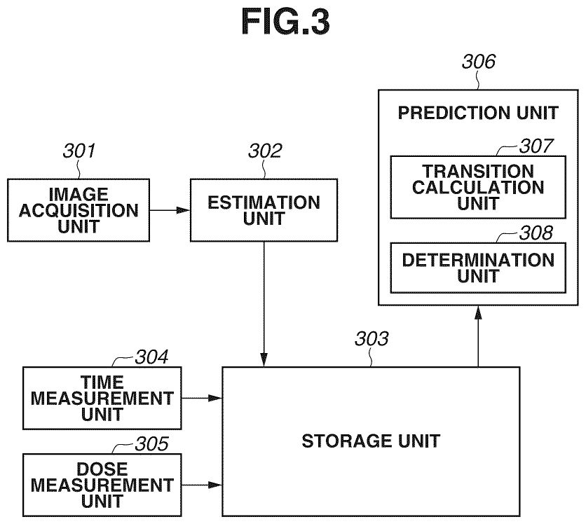

For example, the functions illustrated in FIG. 3 (described below) and flowcharts (described below) are implemented when the CPU 201 reads a program stored in the ROM 202 or the storage device 204 and executes the read program.

FIG. 3 illustrates an example of a functional configuration of the control unit 115 and the storage unit 116 of the radiation imaging apparatus 105. The radiation imaging apparatus 105 includes an image acquisition unit 301, an estimation unit 302, a storage unit 303, a time measurement unit 304, a dose measurement unit 305, and a prediction unit 306. For example, the image acquisition unit 301, the estimation unit 302, the time measurement unit 304, the dose measurement unit 305, and the prediction unit 306 are implemented by the control unit 115. The storage unit 303 is implemented by the storage unit 116.

The image acquisition unit 301 acquires images output from the sensor substrate 111 for detecting the radiation. The estimation unit 302 estimates the degradation degree of the radiation imaging apparatus 105 (sensor substrate 111) based on images acquired by the image acquisition unit 301. As an evaluation index for the degradation degree of the radiation imaging apparatus 105, the estimation unit 302 estimates, for example, the variation (shift amount) of the threshold voltage of switching elements related to the sensor substrate 111, the number of defective pixels, and the image average output as degradation amounts. The degradation degree (degradation amount) related to the sensor substrate 111 estimated by the estimation unit 302 is stored in the storage unit 303.

The time measurement unit 304 measures the irradiation time in the radiation imaging apparatus 105. The dose measurement unit 305 measures the cumulative dose of the radiation radiated to the radiation imaging apparatus 105. The radiation irradiation time measured by the time measurement unit 304 and the cumulative radiation dose measured by the dose measurement unit 305 are stored in the storage unit 303. The time measurement unit 304 may be omitted if the prediction of the transition of the degradation degree (degradation amount) by the prediction unit 306 does not include the prediction of the transition of the degradation degree (degradation amount) over time. Likewise, the dose measurement unit 305 may be omitted if the prediction of the transition of the degradation degree (degradation amount) by the prediction unit 306 does not include the prediction of the transition of the degradation degree (degradation amount) with respect to the cumulative radiation dose.

The prediction unit 306 predicts the life of the radiation imaging apparatus 105 (sensor substrate 111) based on information about the degradation degree (degradation amount) of the radiation imaging apparatus 105 (sensor substrate 111) stored in the storage unit 303. The prediction unit 306 includes a transition calculation unit 307 and a determination unit 308. The transition calculation unit 307 predicts a transition of the degradation degree (degradation amount) of the radiation imaging apparatus 105 based on information about the degradation degree (degradation amount) of the radiation imaging apparatus 105 (sensor substrate 111) estimated by the estimation unit 302 and stored in the storage unit 303. The determination unit 308 determines the life of the radiation imaging apparatus 105 (sensor substrate 111) based on a result of the prediction of the degradation degree (degradation amount) by the transition calculation unit 307, and a determination threshold value. The determination unit 308 determines the time when the degradation degree (degradation amount) having been subjected to the transition prediction by the transition calculation unit 307 exceeds a predetermined determination threshold value, as the life of the radiation imaging apparatus 105 (sensor substrate 111).

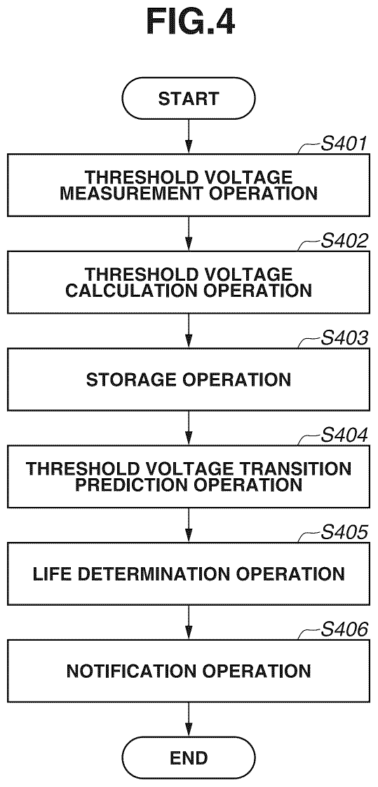

An example for determining the life of the radiation imaging apparatus 105 will be described below. This determination is based on the prediction of the transition of the threshold voltage of switching elements of the pixels included in the sensor substrate 111, where the threshold voltage is used as the degradation amount of the radiation imaging apparatus 105. FIG. 4 is a flowchart illustrating an example of life prediction processing of the radiation imaging apparatus 105 according to the first exemplary embodiment.

In step S401, the radiation imaging apparatus 105 performs a threshold voltage measurement operation. In the threshold voltage measurement operation, the image acquisition unit 301 acquires an image output from the sensor substrate 111, having the pixel value corresponding to the threshold voltage of the switching elements of the pixels included in the sensor substrate 111.

In step S402, the radiation imaging apparatus 105 performs a threshold voltage calculation operation. In the threshold voltage calculation operation, the estimation unit 302 calculates the threshold voltage for each pixel based on the image acquired in step S401 and generates a two-dimensional map (threshold voltage map) that records the threshold voltage for each pixel coordinate.

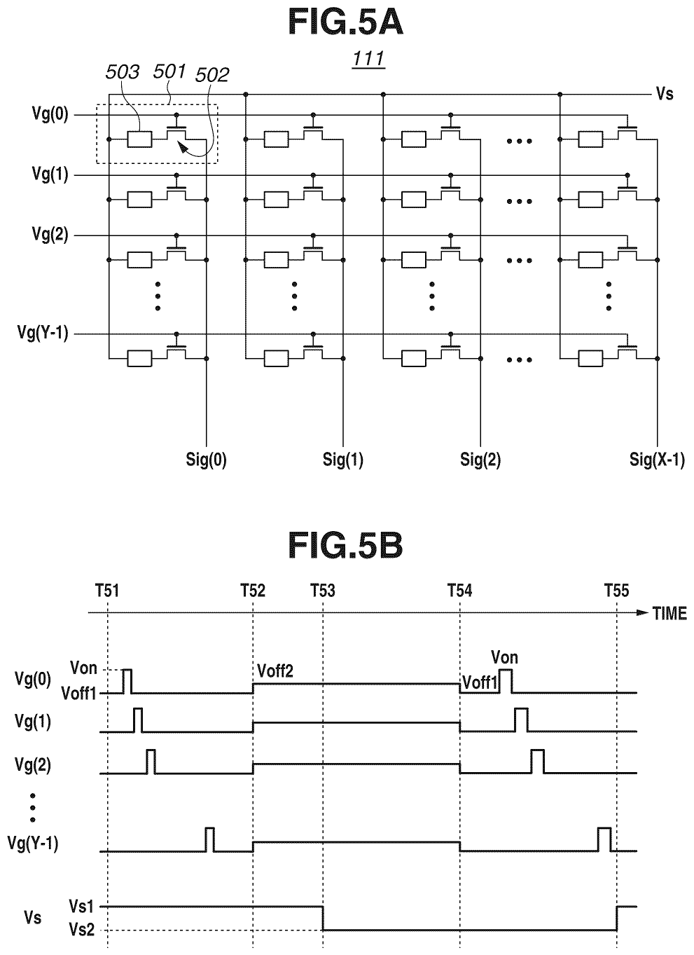

The measurement and calculation of the threshold voltage performed in steps S401 and S402 can be implemented by the technique discussed in Japanese Patent Application Laid-Open No. 2023-95507. The measurement and calculation of the threshold voltage by the method discussed in Japanese Patent Application Laid-Open No. 2023-95507 will be described below with reference to FIGS. 5A and 5B.

FIG. 5A illustrates an example configuration of the sensor substrate 111. The sensor substrate 111 includes a plurality of pixels 501 for detecting a radiation in a matrix form. Although FIG. 5A illustrates some pixels 501 in the sensor substrate 111 to simplify the description, the sensor substrate 111 actually includes more pixels. For example, with the 17 inches×17 inches, the sensor substrate 111 can be disposed with the pixels 501 in about 2,800 rows by about 2,800 columns.

Each of the pixels 501 includes a conversion element 503 for converting a radiation or light into electric charges, and a switching element 502 connected with the conversion element 503. An electrical signal corresponding to the electric charges accumulated in the conversion element 503 is output via the switching element 502. The switching element 502 is a transistor such as a thin film transistor (TFT) and includes a gate electrode, a source electrode, a drain electrode, and a channel layer. From the viewpoint of the increase in the processing speed and definition of the radiation imaging apparatus 105, oxide semiconductors, e.g., amorphous oxide semiconductors such as Indium Gallium Zinc Oxide (IGZO) and Indium Zinc Oxide (IZO) can be used as the channel layer of the TFT.

The conversion element 503 is an indirect or direct conversion element for converting a radiated radiation into electric charges. An indirect conversion element includes a wavelength converter for converting a radiation into light and a photoelectric conversion element for converting light into electric charges. A direct conversion element is a photoelectric conversion element for directly converting a radiation into electric charges. As an example of an indirect conversion element, a conversion element using a p-intrinsic-n (PIN) diode mainly composed of amorphous silicon (a-Si) will be described below.

The conversion element 503 includes an individual electrode for taking out a signal, a common electrode to be supplied with a bias potential, and a photoelectric conversion layer mainly composed of a-Si sandwiched between the two electrodes. The photoelectric conversion layer is composed of a PIN diode including an n+ type semiconductor close to the individual electrode, and a p+ type semiconductor close to the common electrode. The individual electrode of the conversion element 503 is connected to the source electrode of the switching element 502, and the common electrode of the conversion elements 503 is connected to a common bias line Vs. The bias line Vs is supplied with a bias potential from a bias power source (not illustrated). Although, referring to FIG. 5A, the bias line Vs extends in the column direction, it may extend in the row direction.

The gate electrodes as the control electrodes for the switching elements 502 of pixels in the k-th row (k=0 to Y−1) are commonly connected with a drive line Vg(k) corresponding to the row of the drive circuit 113. The drive circuit 113 supplies a drive signal to the switching elements 502 via the drive lines Vg(0), Vg(1), . . . , Vg(Y−1) to control the conductive state of the switching elements 502. The drain electrodes of the switching elements 502 of pixels in the j-th column (j=0 to X−1) are commonly connected with a signal line Sig (j) corresponding to the column of the readout circuit 112. The source electrode of each switching element 502 is connected to the individual electrode of the conversion element 503 of the pixel where the switching element 502 is disposed.

In the threshold voltage measurement operation in step S401, by subjecting the sensor substrate 111 configured as illustrated in FIG. 5A to drive control illustrated in FIG. 5B under the control of the control unit 115, an image having pixel values corresponding to the threshold voltage can be acquired.

Firstly, during the period from time T51 to T52, reset processing is performed. During the reset processing, the drain electrodes of the switching elements 502 are supplied with a reference potential Vref via the signal lines Sig(0), Sig(1), . . . , Sig(X−1). Then, the control unit 115 sequentially sets the potential of the drive line Vg(k) to a conduction potential Von to discharge unnecessary electric charges accumulated in the conversion elements 503 (such as dark electric charges by the dark current of the conversion elements 503) to the readout circuit 112 to reset the conversion elements 503. Thus, the amount of electric charges accumulated in the conversion elements 503 becomes approximate 0, and the conversion elements 503 are reset. Since this processing is intended to discharge unnecessary electric charges, the control unit 115 does not need to form a two-dimensional image. After the reset processing, the control unit 115 sets the potential of the drive line Vg(k) to a potential Voff1 to put the switching elements 502 in the non-conductive state.

Then, at time T52, the control unit 115 changes the potential of the drive lines Vg(0), Vg(1), . . . , Vg(Y−1) for all rows from the potential Voff1 to a potential Voff2. The potential Voff2 is a negative potential lower than the potential Voff1 (Voff1<Voff2<Vref). The control unit 115 maintains the non-conductive state of the switching elements 502. Thus, in each switching element 502, the gate-source voltage is smaller than that in a case of the potential Voff1. The non-conductive state in this timing can be weaker than the non-conductive state in the normal OFF condition of the switching element 502.

At time T53, the control unit 115 changes the bias potential Vs from a potential Vs1 to a potential Vs2 (Vs2<Vs1). At this timing, a potential difference (Vs2−Vs1) transiently arises in the pixel electrodes, and the amount of electric charges, Q=C1×(Vs2−Vs1), is applied to the conversion element 503. C1 denotes the capacitance of the depleted conversion element 503. Then, the potential of the individual electrode of the conversion element 503 also changes from Vref to Vref+(Vs2−Vs1). At this timing, the gate-source voltage Vgs of the switching element 502 is given by the following equation 1:

$$V gs = V off 2 - V ref - ( v s 2 - V s 1 ) \qquad ( Equation 1 )$$

The values Vs1, Vs2, Voff2, and Vref are suitably set to satisfy Vgs>V0, where V0 is the threshold voltage of the switching element 502. The gate-source voltage Vgs at this timing is smaller than that at the signal readout time in the normal imaging operation.

More specifically, the conductive state of the switching element 502 at this timing is weaker than the conductive state at the signal readout time in the normal imaging operation.

If this weak conductive state is maintained, some of electric charges Q having been applied to the conversion element 503 gradually flows out to the readout circuit 112 as a leak current flowing in the switching element 502, through the variation of the bias potential Vs. The control unit 115 maintains the conductive state without changing the drive line and bias potentials for the time duration during which the leak current of the switching element 502 is settled to approximate 0. When the potential of the individual electrode of the conversion element 503 becomes (Voff2−V0), the leak current of the switching element 502 becomes approximate 0. At this timing, the amount of remaining electric charges, Q′ in the conversion element 503 is given by the following equation 2:

$${Q}^{′} = C 1 \times ( V ref - V off 2 + V 0 ) \qquad ( Equation 2 )$$

If the threshold voltage V0 of the switching element 502 is different for each pixel, the value of the amount of remaining electric charges, Q′, is also different for each pixel, and hence the amount of electric charges, Q′, is acquired for each pixel.

At time T54 when the time duration during which the leak current of the switching element 502 is settled to approximate 0 since time T53 has elapsed, the control unit 115 returns the potentials of the drive lines Vg(0), Vg(1), . . . , Vg(Y−1) for all rows from the potential Voff2 to the potential Voff1. Then, the control unit 115 sequentially applies the conduction potential Von to the drive line Vg(k) to turn ON the switching elements 502, thus sequentially transferring the remaining electric charges Q′ in the conversion elements 503 of each row to the readout circuit 112. The image acquisition unit 301 acquires image data based on the amount of electric charges having been transferred from the conversion elements 503 to the readout circuit 112.

The estimation unit 302 acquires the value of the amount of electric charges, Q′, based on the image data acquired as described above. Then, the estimation unit 302 calculates the threshold voltage V0 corresponding to each pixel by using Equation 2 (described above) based on the acquired value of the amount of electric charges, Q′, and generates a two-dimensional map (threshold voltage map) that records the threshold voltage for each pixel coordinate.

The measurement and calculation of the threshold voltage in steps S401 and S402 are not limited to the above-described method. For example, the measurement and calculation may be performed by using a method for directly measuring the current voltage characteristics of the switching element and other known methods.

Referring back to FIG. 4, in step S403, the radiation imaging apparatus 105 performs a storage operation, and the estimation unit 302 stores the threshold voltage map generated in step S402 in the storage unit 303.

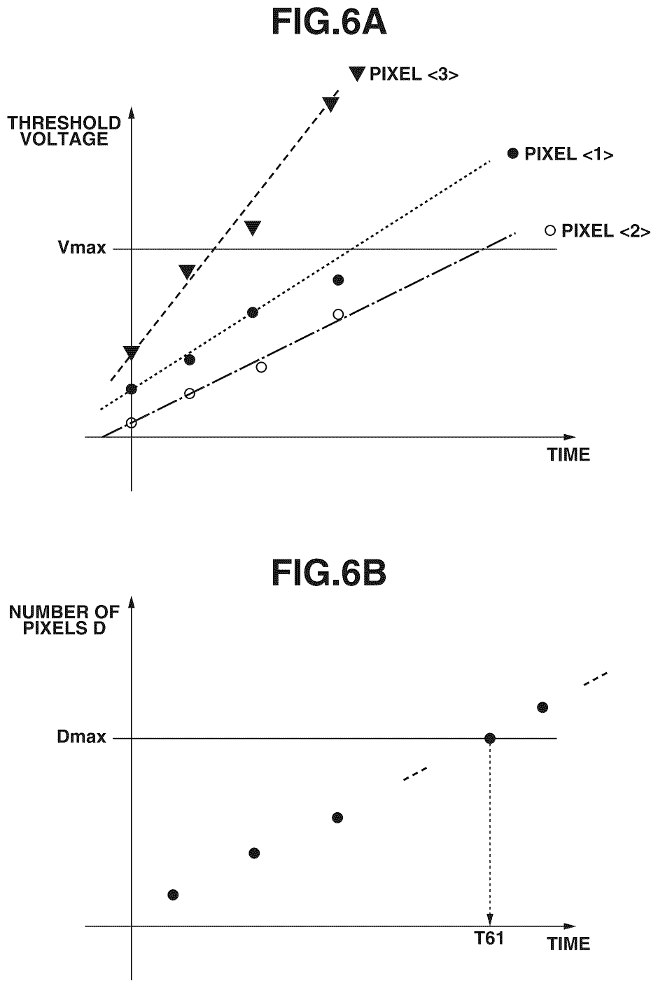

In step S404, the radiation imaging apparatus 105 performs a threshold voltage transition prediction operation. In the threshold voltage transition prediction operation, the transition calculation unit 307 of the prediction unit 306 references a plurality of threshold voltage maps stored in the storage unit 303 and predicts a transition of the threshold voltage of the switching element 502 for each pixel. For example, the transition calculation unit 307 references a plurality of threshold voltage maps for each time series stored in the storage unit 303 and generates a prediction line for the transition of the threshold voltage over time for each pixel. The transition calculation unit 307 predicts a transition of the threshold voltage by using an approximation curve. For example, the transition calculation unit 307 may generate a prediction line for the transition of the threshold voltage by using the linear approximation as illustrated in FIG. 6A or by performing the approximation with a curve. In addition, the transition calculation unit 307 may generate a prediction line in consideration of the dose rate stored in the storage unit 303 and the dependence of the change speed of the threshold voltage. Subsequently, the transition calculation unit 307 calculates a time transition of the number of pixels, D, based on the prediction line as illustrated in FIG. 6B, assuming that the threshold voltage is out of a predetermined range for a total of D pixels. The predetermined range is assumed to be a range from around +1V to around −3V according to the characteristics of the switching element 502. For the prediction, the control unit 115 may use all of threshold voltage maps acquired in the past or threshold voltage maps for the last several times of acquisition. Further, the control unit 115 may generate not only a prediction line for the transition of the threshold voltage over time but also a prediction line for the transition of the threshold voltage with respect to the cumulative radiation dose.

In step S405, the radiation imaging apparatus 105 performs a life determination operation. In the life determination operation, the determination unit 308 of the prediction unit 306 determines the life of the radiation imaging apparatus 105 based on a result of the prediction of the transition of the threshold voltage by the transition calculation unit 307. The determination unit 308 determines the time (time T61 in the example illustrated in FIG. 6B) when the number of pixels, D, predicted by the transition calculation unit 307 in step S404 exceeds a tolerance Dmax as a predetermined reference value (determination threshold value), as the life of the radiation imaging apparatus 105. The tolerance Dmax needs to be set within a range that ensures the image quality not affecting electronic component testing. For example, preferably, the tolerance Dmax may be set to 0.01% of the total number of pixels included in the sensor substrate 111.

In step S406, the radiation imaging apparatus 105 performs a notification operation to notify the user of the time when the radiation imaging apparatus 105 reaches the life determined in step S405. As a method for notifying the user of the life of the radiation imaging apparatus 105, the control unit 115 may notify the computer for controlling the radiation imaging apparatus 105 of the time when the apparatus reaches the life, or display a life indicator on the display unit of the radiation imaging system 100.

The radiation imaging apparatus 105 can perform the life prediction processing illustrated in FIG. 4 again according to any desired condition. For example, preferably, the control unit 115 may perform the processing when any desired time period has elapsed since the last life prediction processing, or before or after the radiation imaging apparatus 105 performs calibration (updates a sensitivity map).

The radiation imaging apparatus 105 may automatically perform the above-described life prediction processing according to any desired condition without following instructions from the outside of the radiation imaging apparatus 105. For example, the radiation imaging apparatus 105 may perform the life prediction processing at a timing controlled by the computer of the radiation imaging system 100 or a timing specified by the user.

According to the first exemplary embodiment, the control unit 115 predicts a transition of the threshold voltage of the switching element 502 calculated based on the acquired image by using the threshold voltage of the switching element 502 as the degradation amount of the radiation imaging apparatus 105, and determines the life of the radiation imaging apparatus 105 based on the prediction result. Thus, the control unit 115 can predict the life of the radiation imaging apparatus 105 based on the acquired image. If the life of the radiation imaging apparatus 105 can be predicted in this way, the user can replace the radiation imaging apparatus 105 at a suitable timing before the apparatus reaches the life.

Also, when generating a threshold voltage map by calculating values not for each pixel but for each region including a plurality of pixels, the radiation imaging apparatus 105 can also perform the life prediction processing like the above-described example. In a case where values are calculated for each region, in the threshold voltage transition prediction operation in step S404, the transition calculation unit 307 of the prediction unit 306 needs to generate a prediction curve for the transition of the threshold voltage over time for each region by using a representative value (average value, maximal value, minimal value, or median) of the threshold voltage in the region. In the life determination operation in step S405, the determination unit 308 of the prediction unit 306 needs to determine the region exceeding the range predetermined by the representative value of the threshold voltage in the region, as a defective region, and determine the life of the radiation imaging apparatus 105 assuming the total number of defective regions as the number of defectives, D. In this case, preferably, the tolerance Dmax used for the life determination operation needs to be the permitted maximal value determined for the total number of defective regions. Further, the control unit 115 may determine the life of the radiation imaging apparatus 105 by using a part of the acquired image, i.e., only the degradation degree (degradation amount) in a specific region of the pixel region. For example, the control unit 115 may determine the life of the radiation imaging apparatus 105 based only on the degradation degree (degradation amount) in the central region of the pixel region.

A second exemplary embodiment (described below) differs from the above-described first exemplary embodiment in that the number of defective pixels is used as the degradation amount of the radiation imaging apparatus 105. The configurations of the radiation imaging system 100 and the radiation imaging apparatus 105 according to the second exemplary embodiment are similar to those according to the above-described first exemplary embodiment, and redundant descriptions thereof will be omitted.

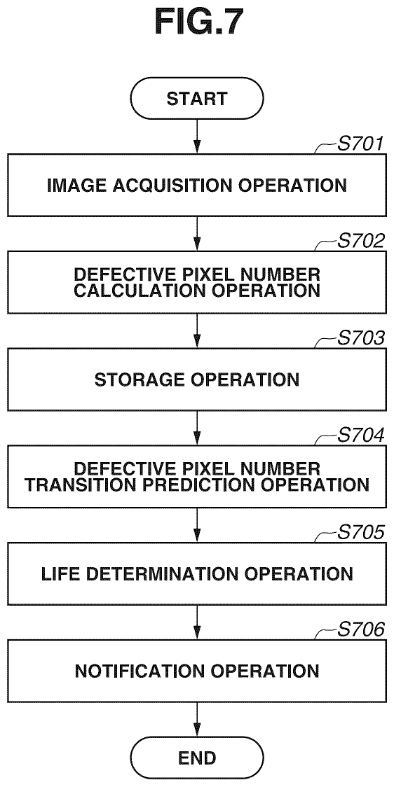

An example for determining the life of the radiation imaging apparatus 105 will be described below. This determination is based on the prediction of the transition of the number of defective pixels, where the number is used as the degradation amount of the radiation imaging apparatus 105. FIG. 7 is a flowchart illustrating an example of the life prediction processing of the radiation imaging apparatus 105 according to the second exemplary embodiment.

In step S701, the radiation imaging apparatus 105 performs an image acquisition operation, and the image acquisition unit 301 acquires an image output from the sensor substrate 111 having the pixel values corresponding to the radiated radiation dose.

In step S702, the radiation imaging apparatus 105 performs a defective pixel number calculation operation. In the defective pixel number calculation operation, the estimation unit 302 calculates the number of defective pixels based on the image acquired in step S701. The estimation unit 302 extracts defective pixels from the image acquired in step S701 based on a predetermined criterion and calculates the number of defective pixels.

In step S703, the radiation imaging apparatus 105 performs a storage operation, and the estimation unit 302 stores the number of defective pixels calculated in step S702 in the storage unit 303.

In step S704, the radiation imaging apparatus 105 performs a defective pixel number transition prediction operation. In the defective pixel number transition prediction operation, the transition calculation unit 307 of the prediction unit 306 references a plurality of pieces of information about the number of defective pixels stored in the storage unit 303 and predicts a transition of the number of defective pixels.

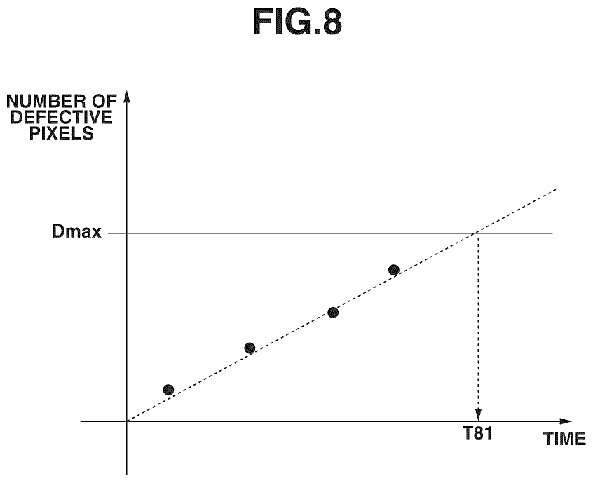

For example, the transition calculation unit 307 references a plurality of pieces of time-series information related to the number of defective pixels stored in the storage unit 303 and generates a prediction line for the transition of the number of defective pixels over time. The transition calculation unit 307 predicts a transition of the number of defective pixels by using an approximation curve. For example, the transition calculation unit 307 may generate a prediction line for the transition of the number of defective pixels by using the linear approximation as illustrated in FIG. 8 or by performing the approximation with a curve. For the prediction, the control unit 115 may use all of information about the number of defective pixels used for the prediction or information about the last several times of acquisition. Further, the control unit 115 may generate not only a prediction line for the transition of the number of defective pixels over time but also a prediction line for the transition of the number of defective pixels with respect to the cumulative radiation dose.

In step S705, the radiation imaging apparatus 105 performs the life determination operation. In the life determination operation, the determination unit 308 of the prediction unit 306 determines the life of the radiation imaging apparatus 105 based on a result of the prediction of the transition of the number of defective pixels by the transition calculation unit 307. The determination unit 308 determines the time (time T81 in the example illustrated in FIG. 8) when the total number of defective pixels, D, predicted by the transition calculation unit 307 in step S704 exceeds the tolerance Dmax as a predetermined reference value (determination threshold value), as the life of the radiation imaging apparatus 105. The tolerance Dmax needs to be set within a range that ensures the image quality not affecting electronic component testing. For example, preferably, the tolerance Dmax may be set to 0.01% of the total number of pixels included in the sensor substrate 111.

In step S706, the radiation imaging apparatus 105 performs the notification operation to notify the user of the time when the radiation imaging apparatus 105 reaches the life determined in step S705. As a method for notifying the user of the life of the radiation imaging apparatus 105, the control unit 115 may notify the computer for controlling the radiation imaging apparatus 105 of the time when the apparatus reaches the life, or display a life indicator on the display unit of the radiation imaging system 100.

Although, in the above-described example, the number of defective pixels is calculated by using a radiation image, the control unit 115 may calculate the number of defective pixels by using a dark image with no signal applied.

The radiation imaging apparatus 105 can perform the life prediction processing illustrated in FIG. 7 again according to any desired condition. The radiation imaging apparatus 105 may automatically perform the above-described life prediction processing according to any desired condition without following instructions from the outside of the radiation imaging apparatus 105.

According to the second exemplary embodiment, the control unit 115 predicts a transition of the number of defective pixels calculated based on the acquired image by using the number of defective pixels as the degradation amount of the radiation imaging apparatus 105, and determines the life of the radiation imaging apparatus 105 based on the prediction result. Thus, the control unit 115 can predict the life of the radiation imaging apparatus 105 based on the acquired image. If the life of the radiation imaging apparatus 105 can be predicted in this way, the user can replace the radiation imaging apparatus 105 at a suitable timing before the apparatus reaches the life.

A third exemplary embodiment (described below) differs from the above-described first and second exemplary embodiments in that the image average output of the radiation image is used as the degradation amount of the radiation imaging apparatus 105. The configurations of the radiation imaging system 100 and the radiation imaging apparatus 105 according to the third exemplary embodiment are similar to those according to the above-described first exemplary embodiment, and redundant descriptions thereof will be omitted.

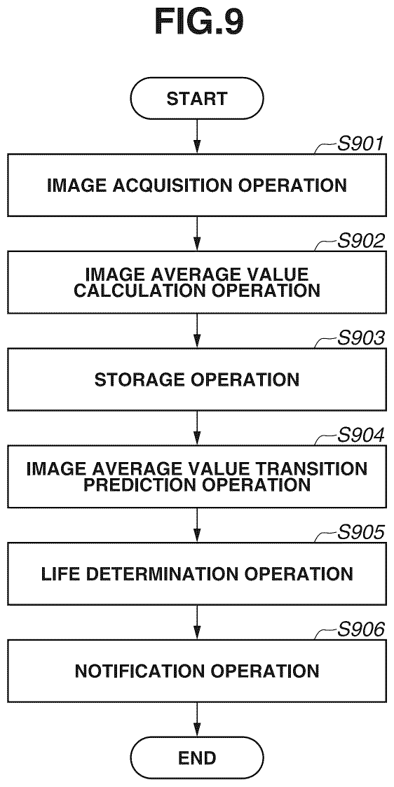

An example for determining the life of the radiation imaging apparatus 105 will be described below. This determination is based on the prediction of the transition of an image average value (average output of the radiation image), where the average output is used as the degradation amount of the radiation imaging apparatus 105. FIG. 9 is a flowchart illustrating an example of the life prediction processing of the radiation imaging apparatus 105 according to the third exemplary embodiment.

In step S901, the radiation imaging apparatus 105 performs an image acquisition operation, and the image acquisition unit 301 acquires an image output from the sensor substrate 111 having the pixel values corresponding to the radiated radiation dose. Preferably, the irradiation dose of a radiation is the irradiation dose equivalent to the life prediction processing performed in the past.

In step S902, the radiation imaging apparatus 105 performs an image average value calculation operation. In the image averaging value calculation operation, the estimation unit 302 calculates the average value of the image based on the image acquired in step S901.

In step S903, the radiation imaging apparatus 105 performs a storage operation, and the estimation unit 302 stores the image average value calculated in step S902 in the storage unit 303.

In step S904, the radiation imaging apparatus 105 performs an image average value transition prediction operation. In the image average value transition prediction operation, the transition calculation unit 307 of the prediction unit 306 references a plurality of pieces of information about the image average value stored in the storage unit 303 and predicts a transition of the image average value.

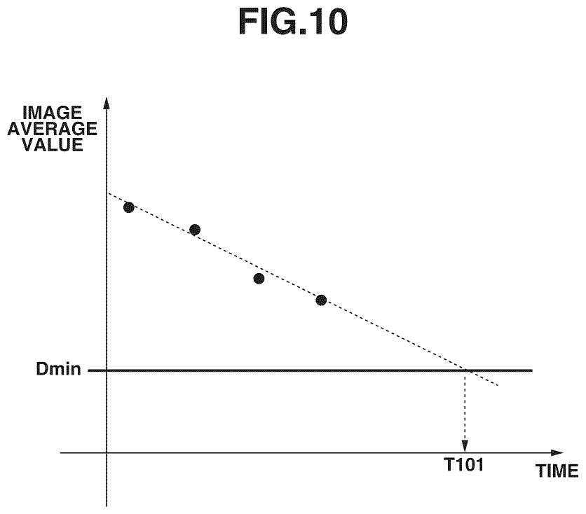

For example, the transition calculation unit 307 references a plurality of pieces of time-series information related to the image average value stored in the storage unit 303 and generates a prediction line for the transition of the image average value over time. The transition calculation unit 307 predicts a transition of the image average value by using an approximation curve. For example, the transition calculation unit 307 may generate a prediction line for the transition of the image average value by using the linear approximation as illustrated in FIG. 10 or by performing the approximation with a curve. For the prediction, the control unit 115 may use all of information about the image average value used for the prediction or information about the last several times of acquisition. Further, the control unit 115 may generate not only a prediction line for the transition of the image average value over time but also a prediction line for the transition of the image average value with respect to the cumulative radiation dose.

In step S905, radiation imaging apparatus 105 performs the life determination operation. In the life determination operation, the determination unit 308 of the prediction unit 306 determines the life of the radiation imaging apparatus 105 based on a result of the prediction of the transition of the image average value by the transition calculation unit 307. The determination unit 308 determines the time (time T101 in the example illustrated in FIG. 10) when the image average value predicted by the transition calculation unit 307 in step S904 falls down to a tolerance Dmin as a predetermined reference value (determination threshold value) or below, as the life of the radiation imaging apparatus 105.

In step S906, the radiation imaging apparatus 105 performs the notification operation to notify the user of the time when the radiation imaging apparatus 105 reaches the life determined in step S905. As a method for notifying the user of the life of the radiation imaging apparatus 105, the control unit 115 may notify the computer for controlling the radiation imaging apparatus 105 of the time when the apparatus reaches the life, or display a life indicator on the display unit of the radiation imaging system 100.

The radiation imaging apparatus 105 can perform the life prediction processing illustrated in FIG. 9 again according to any desired condition. The radiation imaging apparatus 105 may automatically perform the above-described life prediction processing according to any desired condition without following instructions from the outside of the radiation imaging apparatus 105.

According to the third exemplary embodiment, the control unit 115 predicts a transition of the image average value calculated based on the acquired image by using the image average output as the degradation amount of the radiation imaging apparatus 105, and determines the life of the radiation imaging apparatus 105 based on the prediction result. Thus, the control unit 115 can predict the life of the radiation imaging apparatus 105 based on the acquired image. If the life of the radiation imaging apparatus 105 can be predicted in this way, the user can replace the radiation imaging apparatus 105 at a suitable timing before the apparatus reaches the life.

### Other Exemplary Embodiments of Present Disclosure

The present disclosure can also be achieved when a program for implementing at least one of the functions according to the above-described exemplary embodiments is supplied to a system or apparatus via a network or storage medium, and at least one processor in the computer of the system or apparatus reads and executes the program. Further, the present disclosure can also be achieved by a circuit such as an application specific integrated circuit (ASIC) for implementing at least one function.

The above-described exemplary embodiments are to be considered as illustrative in embodying the present disclosure, and are not to be interpreted as restrictive on the technical scope of the present disclosure. The present disclosure may be embodied in diverse forms without departing from the technical concepts or essential characteristics thereof.

The present disclosure makes it possible to predict the life of a radiation imaging apparatus based on acquired image information.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-193921, filed Nov. 14, 2023, which is hereby incorporated by reference herein in its entirety.

What is claimed is:

1. A radiation imaging apparatus comprising:
an acquisition unit configured to acquire an image from an imaging unit having a plurality of pixels for detecting a radiation;
an estimation unit configured to estimate a degradation degree of the radiation imaging apparatus based on the image acquired by the acquisition unit; and
a prediction unit configured to predict a life of the radiation imaging apparatus based on a prediction of a transition of the degradation degree of the radiation imaging apparatus acquired by the estimation unit.

2. The radiation imaging apparatus according to claim 1, wherein the prediction unit comprises:
a calculation unit configured to predict a transition of the degradation degree based on the degradation degree of the radiation imaging apparatus acquired by the estimation unit; and
a determination unit configured to determine the life of the radiation imaging apparatus based on a result of the prediction of the degradation degree by the calculating unit and a determination threshold value.

3. The radiation imaging apparatus according to claim 1,
wherein the estimation unit estimates a variation of a threshold voltage of a switching element included in the pixel based on the acquired image, and
wherein the prediction unit predicts a transition of the variation of the threshold voltage of the switching element.

4. The radiation imaging apparatus according to claim 1,
wherein the estimation unit estimates the number of defective pixels of the imaging unit based on the acquired image, and
wherein the prediction unit predicts a transition of the number of defective pixels.

5. The radiation imaging apparatus according to claim 1,
wherein the estimation unit estimates an image average output of the imaging unit based on the acquired image, and
wherein the prediction unit predicts a transition of the image average output.

6. The radiation imaging apparatus according to claim 1, further comprising a time measurement unit configured to measure irradiation time of a radiation, wherein the prediction unit predicts of a transition of the degradation degree of the radiation imaging apparatus over the irradiation time.

7. The radiation imaging apparatus according to claim 1, further comprising a dose measurement unit configured to measure a cumulative dose of a radiated radiation, wherein the prediction unit predicts a transition of the degradation degree of the radiation imaging apparatus with respect to the cumulative radiation dose.

8. The radiation imaging apparatus according to claim 1, wherein the prediction unit predicts the degradation degree of the radiation imaging apparatus by using an approximation curve.

9. The radiation imaging apparatus according to claim 1, wherein the prediction unit predicts a transition of the degradation degree of the radiation imaging apparatus based on results of a predetermined number of previously acquired degradation degrees of the radiation imaging apparatus acquired by the estimation unit.

10. The radiation imaging apparatus according to claim 1, wherein the estimation unit estimates the degradation degree of the radiation imaging apparatus based on a representative value for each region of the acquired image.

11. The radiation imaging apparatus according to claim 1, wherein the estimation unit estimates the degradation degree of the radiation imaging apparatus by using a part of the acquired image.

12. A method for evaluating a radiation imaging apparatus, the method comprising:
acquiring an image from an imaging unit having a plurality of pixels for detecting a radiation;
estimating a degradation degree of the radiation imaging apparatus based on the image acquired in the acquisition; and
predicting a life of the radiation imaging apparatus based on a prediction of a transition of the degradation degree of the radiation imaging apparatus acquired in the estimation.

13. A non-transitory computer readable storage medium that stores a program for causing a computer of a radiation imaging apparatus to execute a method comprising:
acquiring an image from an imaging unit having a plurality of pixels for detecting a radiation;
estimating a degradation degree of the radiation imaging apparatus based on the image acquired in the acquisition; and
predicting a life of the radiation imaging apparatus based on a prediction of a transition of the degradation degree of the radiation imaging apparatus acquired in the estimation.
